(19) United States
(12) Patent Application Publication
(10) Pub. No.: US 2017/0273413 A1
(43) Pub. Date: Sep. 28, 2017

(54) Accessory System for Decorating Articles using Ornaments Connected with a Button-Snap Connector

(71) Applicant: Roosevelt Productions, LLC, Miami Beach, FL (US)

(72) Inventors: Tara Katz, Miami Beach, FL (US); Erica Harrison, New York, NY (US)

(73) Assignee: Roosevelt Productions, LLC, Miami Beach, FL (US)

(21) Appl. No.: 15/453,901

(22) Filed: Mar. 8, 2017

Related U.S. Application Data
(60) Provisional application No. 62/305,343, filed on Mar. 8, 2016.

(51) Int. Cl. A44B 17/00; A44C 1/00; A44C 13/00; F16B 39/02; A44B 9/10

(52) U.S. Cl. CPC A44B 17/0082; A44B 17/0041; A44B 17/007; A44B 17/0011; F16B 39/021; A44B 17/0076; A44B 9/10; A44C 13/00; A44C 1/00

(57) ABSTRACT

An accessory system can be used to decorate articles with ornaments. The system includes a button-snap connector. The button-snap connector includes a male portion and a female portion. The button-snap connector allows a user to select a particular ornament to be worn on an article of clothing or the like. Likewise, the button-snap connector allows a particular ornament to be used with different articles. The system also include an accessory that can be placed around the button-snap connector to further customize and decorate the article.

### CROSS-REFERENCE TO RELATED APPLICATIONS

This application claims the benefit of U.S. Provisional Application No. 62/305,343, filed Mar. 8, 2016.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the Invention

The invention relates to fashion accessories and in particular to accessories using snap buttons.

Description of the Related Art

Fashion accessories modify and personalize the appearance of clothing and allow wearers to express their individual styles. Pins, appliques, and jewelry are examples of accessories that a given wearer can select to create new looks. If a fashion accessory or a line of accessories becomes popular, the accessory or accessories can form a fashion trend.

Some clothes provide a location for easy attachment of accessories while others cannot be accessorized easily. For example, a lapel pin can be attached easily to a lapel. In contrast, a pin cannot be attached to a plastic hairband. Accordingly, fashion wearers need a standardized way to attach an accessory to different articles of clothing.

Collectibles are another trend in children's accessories. Collectibles can be sold as a line of products. A particular product in a line of collectibles might be preferred by a particular person. For example, a fan of a particular sports team might prefer an accessory reflecting his or her favorite team. In addition, a supply of a particular accessory can be limited to create increased demand and pricing for the particular accessory.

A collector of a line of collectibles may want to change an accessory being worn but may not want to change an underlying article. However, if the accessory is integral (i.e. permanently attached) with the article of clothing, the wearer will have to change both the accessory and the attached article.

Accordingly, a need exists to provide an attachment device that can be attached to a variety of articles and that can be used to connect releaseably to a variety of accessories.

### BRIEF SUMMARY OF THE INVENTION

The invention encompasses an accessory system utilizing a snap button for decorating an article. An article can be a piece of clothing, a necklace, clothing accessory, or other item to be decorated. An object of the invention is to provide a system that allows a plurality of different ornaments to a plurality of articles by using a common (i.e. a standard) button-snap connector.

The accessory system includes a first ornament, a second ornament that is different than the first ornament, and a button-snap connector for connecting the ornament to an article. The button-snap includes a stud portion (i.e. a male portion) and a socket portion (i.e. a female portion). The stud portion can be fixed to the ornament or the article; the socket portion can be fixed to the other of the ornament or the article. Whichever ornament the user prefers can be connected to an article.

The snap button connector holds the ornament to the article securely enough that they stay connected during normal use. The snap button connector is weak enough that the article and the ornament can be separated using hand pressure to separate them.

A further object of the invention is to provide a system that can be further decorated with an accessory. The accessory includes a loop that encircles the socket. The loop itself can be a decoration or can be attached to further decorations. The loop does not need to be circular; the loop can be shaped to complement the perimeter of the socket. While the loop will work as long as the loop can encircle the socket, the loop works better when the loop complements and fits around the perimeter of the socket.

A further object of the invention is to provide a lapel-pin female snap-fastener assembly for connecting to a clothing ornament. The lapel-pin female snap-fastener assembly includes a plate, a female snap-fastener, and a pin. The plate has an exterior surface and an interior surface. The interior surface is on an opposing side of the plate than the exterior surface. The female snap-fastener part is disposed on the exterior surface. The female snap-fastener part has a socket formed therein. The socket is configured to receive a groove on the clothing ornament. The pin is connected to the interior surface. The pin is configured to pierce clothing. A butterfly clutch pin back is placed on the pin to secure the lapel-pin female snap-fastener assembly to the piece of clothing. Despite being called a “lapel-pin”, the pin can be attached to any article of clothing or fabric or the like.

A further object of the invention is to provide an ornament that inhibits rotation of the ornament relative to the female snap-fastener part. The ornament can removably attach to a female snap fastener part. The female snap fastener part has a female-snap-fastener-part outer surface. The female-snap-fastener-part outer surface has a socket formed therein. A spring or springs can be disposed in the female-snap-fastener-part. The spring urges centerward with regard to the socket. The spring extends into a span of the socket when the spring is relaxed. The ornament has an exterior bearing a decoration, a flat interior surface opposing the exterior, and a groove. The groove is disposed on the flat interior surface. The groove has an overhang. The groove is sized small enough to seat in the socket with the flat interior surface abutting the female-snap-fastener-part outer surface. The groove is large enough to displace the spring when the groove is seated in the socket with the flat interior surface abutting the female-snap-fastener-part outer surface. The overhang is far enough from the flat interior surface to be held by said spring when the groove is seated in the socket with the flat interior surface abutting the female-snap-fastener-part outer surface. The overhang is close enough to the flat interior surface to prevent the flat interior surface from separating from the female-snap-fastener-part-outer surface when the groove is seated in the socket.

Other features of the invention are set forth in the appended claims.

Although the invention is illustrated and described herein as embodied in an accessory system for decorating articles using a plurality of ornaments and a button-snap connector, the invention is not limited to the details shown because various modifications and structural changes may be made without departing from the invention and the equivalents of the claims. However, the construction and method of operation of the invention together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective view of a socket of a button snap according to the prior art.

FIG. 2 is a perspective view of a stud of a button snap according to the prior art.

FIG. 3 is a perspective view of a post of a button snap according to the prior art.

FIG. 4A is a front view of a first embodiment of an ornament according to the invention.

FIG. 4B is a rear view of the first embodiment of an ornament, which is shown in FIG. 4A.

FIG. 4C is a side view of the first embodiment of an ornament, which is shown in FIG. 4A.

FIG. 5A is a front view of a second embodiment of an ornament according to the invention.

FIG. 5B is a rear view of the second embodiment of an ornament, which is shown in FIG. 5A.

FIG. 5C is a side view of the second embodiment of an ornament, which is shown in FIG. 5A.

FIG. 6 is a side sectional view of a third embodiment of an ornament according to the invention.

FIG. 7 is an exploded perspective view of the third embodiment of the ornament, which is shown in FIG. 6.

FIG. 8 is a front view of a first embodiment of an accessory according to the invention.

FIG. 9 is a front view of a second embodiment of an accessory according to the invention.

FIG. 10 is a side view of an accessory being placed on a socket.

FIG. 11 is a side view of the accessory shown in FIG. 10 with an ornament securing the accessory to the socket.

FIG. 12 is a front view of a necklace according to the invention.

FIG. 13A is a front view of a zipper pull tab according to the invention.

FIG. 13B is a side view of the zipper pull tab shown in FIG. 13A.

FIG. 14 is a perspective view of a hairband according to the invention.

FIG. 15 is a top view of a bracelet according to the invention.

FIG. 16 is a bottom view of the bracelet shown in FIG. 15.

FIG. 17 is a side view of an embodiment of an ornament that reduces rotation according to the invention.

FIG. 18 is an exploded perspective view of the ornament shown in FIG. 17.

FIG. 19 is a side sectional view of the ornament shown in FIG. 17 while attached to a female snap-fastener part.

FIG. 20 is a front side view of a lapel-pin female snap-fastener part according to the invention.

FIG. 21 is a side view of the lapel-pin female snap-fastener part shown in FIG. 20.

FIG. 22 is a perspective view of a lapel pin and a butterfly clutch pin back according to the prior art.

### DETAILED DESCRIPTION OF THE INVENTION

Embodiments of the invention are described below and are shown in the figures of the drawing.

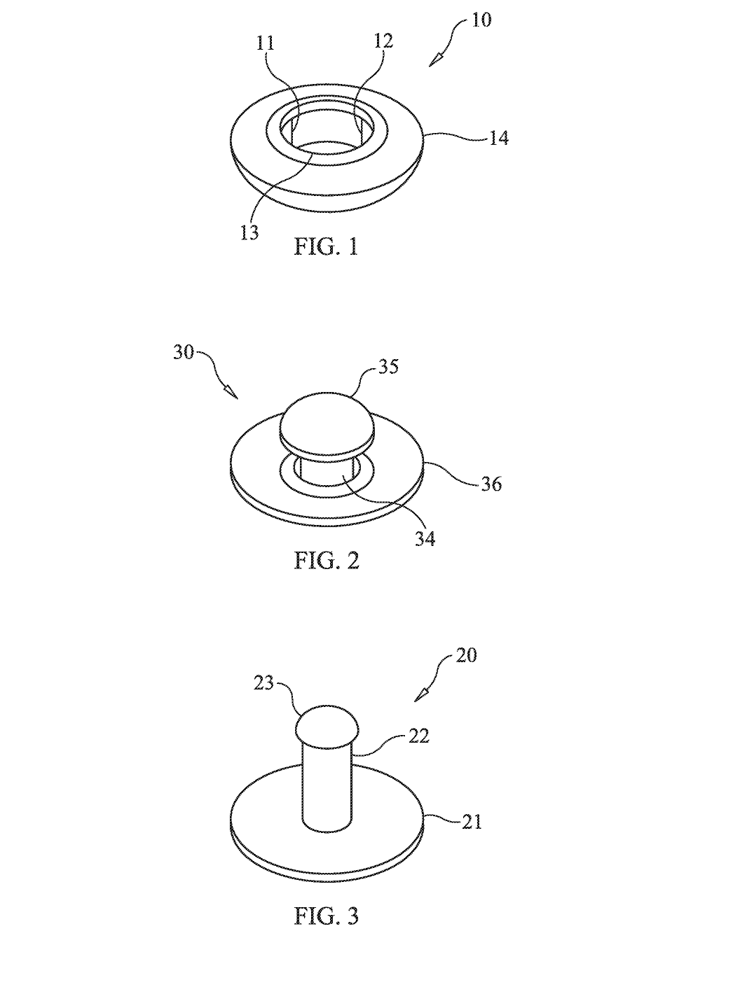

FIGS. 1-3 show a snap button according to the prior art that can be included in the invention.

FIG. 1 shows a preferred embodiment of a female snap-fastener part 10. The female snap-fastener part 10 has an annular shape with a circular perimeter 14. A socket 13 is formed in the female snap-fastener part 10, which is configured to receive a groove as described below. A first spring 11 and a second spring 12 are disposed within the socket 13. The springs 11 and 12 releaseably hold the groove when inserted. The springs 11 and 12 secure the groove with enough force that they will not release the groove during normal wearing. However, the springs 11 and 12 are light enough that the groove can be removed from the female snap-fastener part 10 by hand.

FIG. 2 shows a male snap-fastener part 30. The male snap-fastener part 30 includes an annular backing 36. A cylindrical peg 34 extends from the backing 36. A spherical groove 35 is disposed on the peg 34. As mentioned, the groove 35 inserts in the socket 13 of the female snap-fastener part 10.

FIG. 3 shows a post 20. The post 20 includes an annular head 21. A shaft 22 extends from the center of the head 21. The shaft 22 ends in a deformable tail 23. The tail 23 can be inserted into the rear of a female snap-fastener part 10 or male snap-fastener part 30 and hammered to deform the tail 23 to form a rivet.

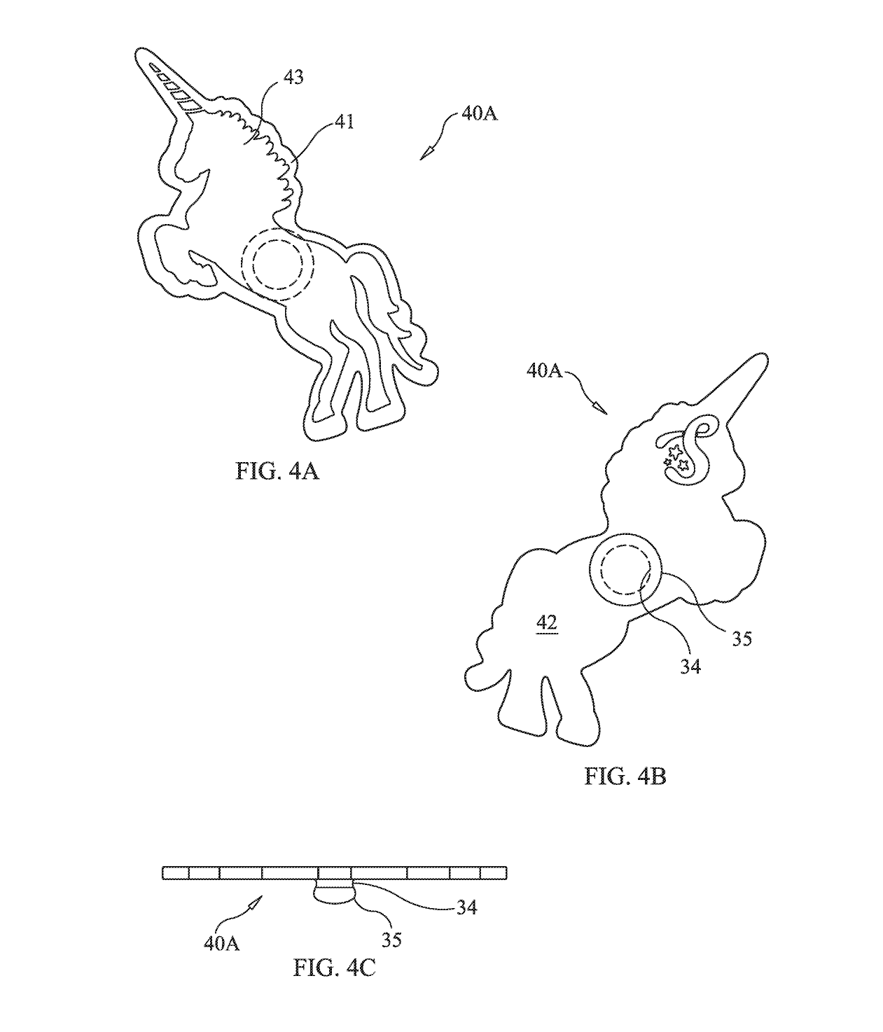

FIGS. 4A, 4B, and 4C show a first embodiment of an ornament 40A. The ornament 40A has an exterior 41. The exterior 41 is visible when the ornament 40A is added. Enamel 43 is painted on the exterior 41. An interior 42 opposes the exterior 41. A groove 35 is disposed on the interior 42.

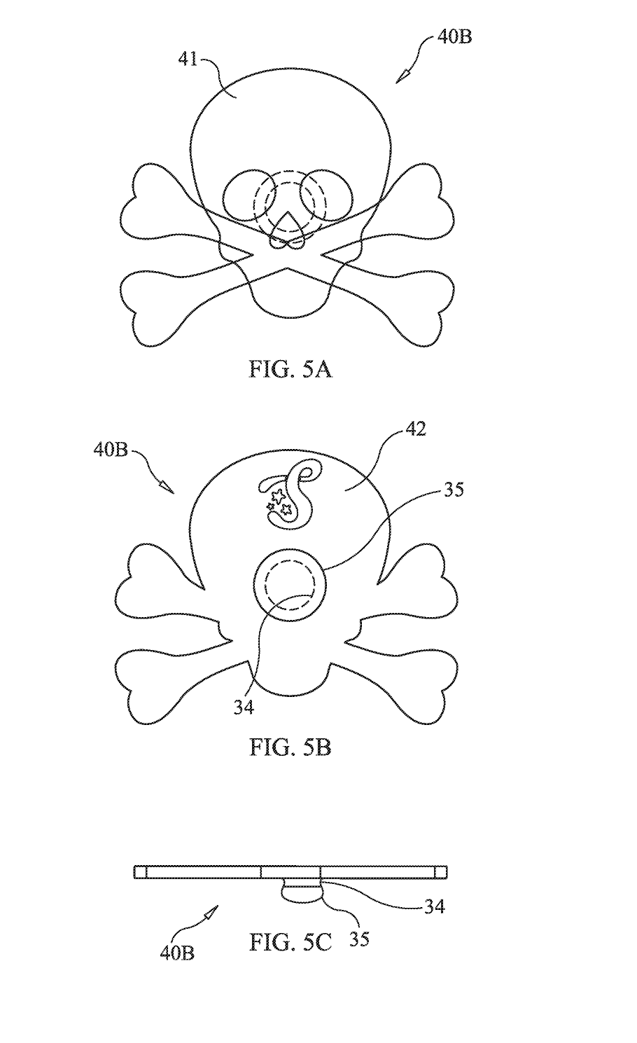

FIGS. 5A, 5B, and 5C show a second embodiment of an ornament 40B. The ornament 40B is different than the ornament 40A. The ornament 40A can be exchanged with the ornament 40B depending on the wearer's preferences.

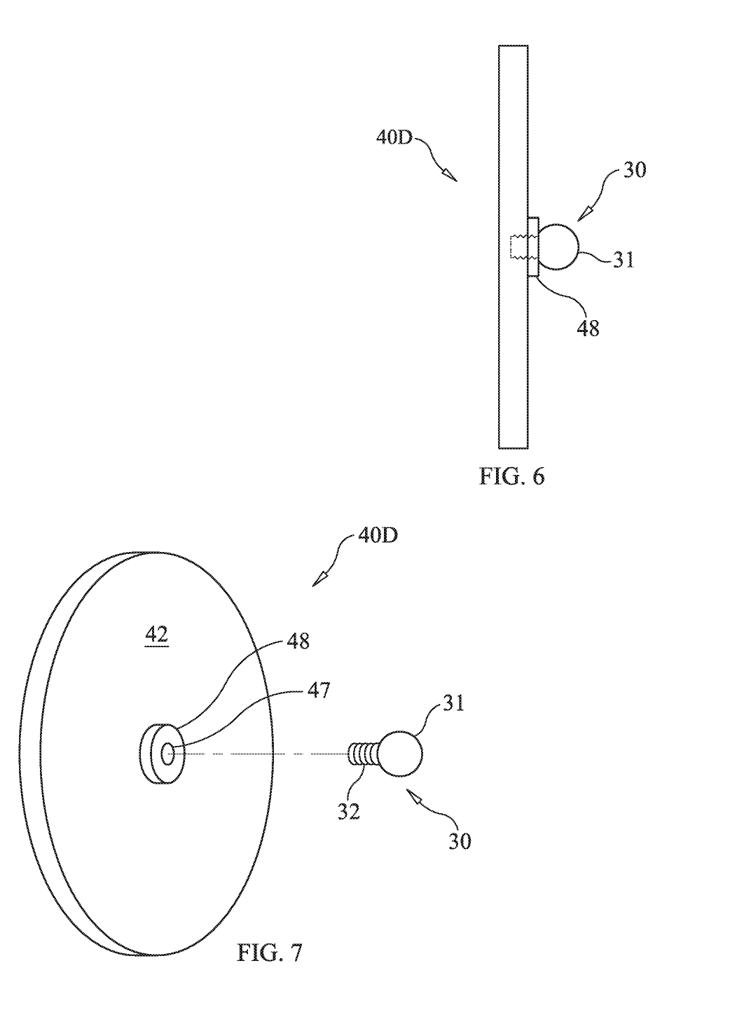

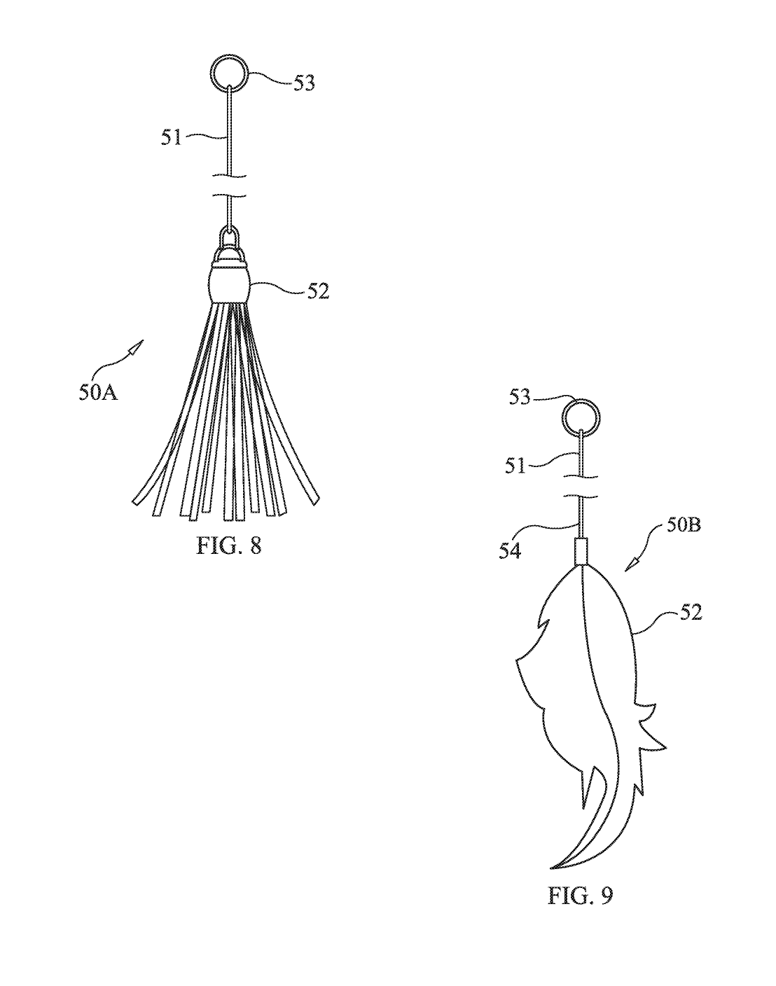

FIGS. 6-7 show how a preferred embodiment of a snap 30 attaches to an ornament 40D. The male snap-fastener part 30 includes a groove 31. A screw 32 extends from the groove 31. The ornament 40 has a nut 48 disposed on the interior 42 of the ornament 40. A threaded hole 47 is formed in the nut 48. The screw 32 is screwed into the threaded hole 47.

FIGS. 8 and 9 show two embodiments of accessories 50A and 50B, respectively. Each accessory 50 includes a loop 53. A dropper 51 is tied to the loop 53 at a first end and to an ornament 52 at a second end. A clasp 54 interconnects the dropper 51 and the ornament 52.

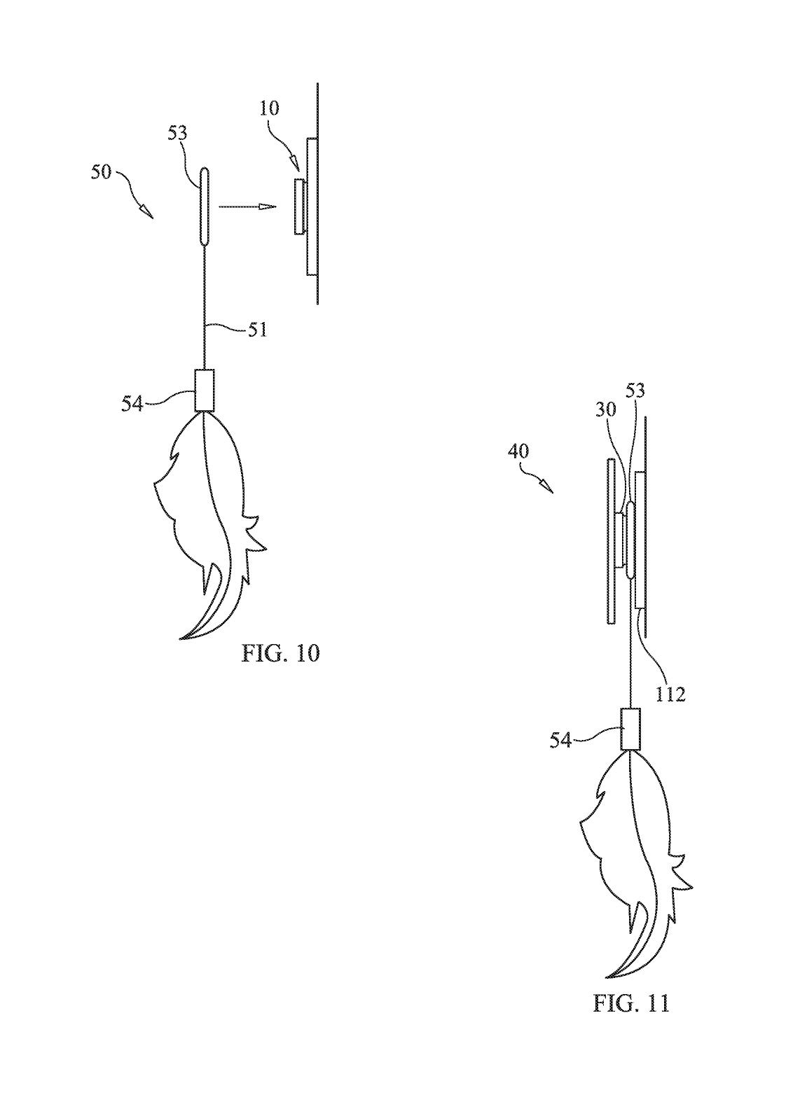

As shown in FIGS. 10 and 11, to connect the accessory 50 to the female snap-fastener part 10, the loop 53 fits over and encircles the female snap-fastener part 10. An ornament 40 is snapped onto the female snap-fastener part 10 to secure the accessory 50. To change or remove the accessory 50, the ornament 40 is pulled from the female snap-fastener part 10 and the loop 53 is pulled from the female snap-fastener part 10.

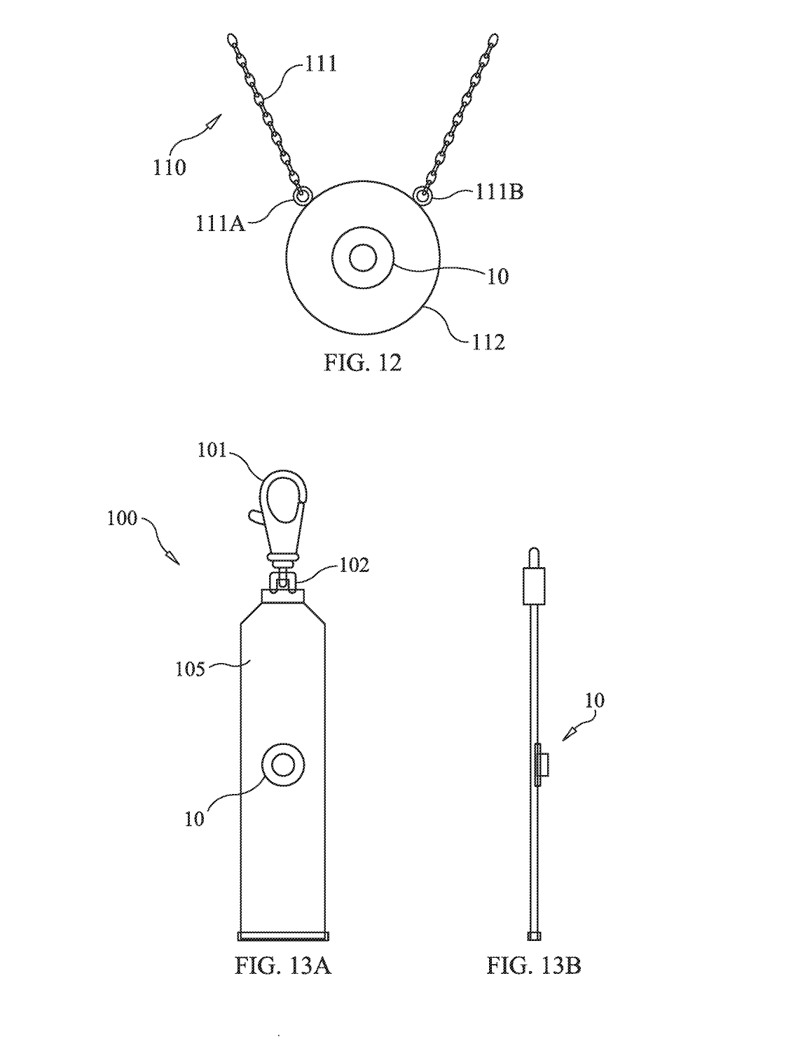

FIG. 12 shows a necklace 110. The necklace 110 includes a chain 111 that can be worn around one's neck. A pendant 112 is connected to two eyes 111A and 111B. The eyes 111A and 111B are connected to respective ends of the chain 111. The pendent 112 has a female snap-fastener part 10 disposed thereon. Accessories 40 and/or 50, which are not shown in FIG. 12, can be attached to the pendent 112 by snapping to the female snap-fastener part 10.

FIGS. 13A and 13B show a zipper pull tab 100. The zipper pull tab 100 has a lobster claw 101 for attaching to zippers or other loops. A swivel 102 interconnects the lobster claw 101 to a tab 103. A female snap-fastener part 10 is disposed on the tab 103. Accessories 40 and/or 50, which are not shown in FIG. 13, can be attached to the tab 103 by snapping to the female snap-fastener part 10.

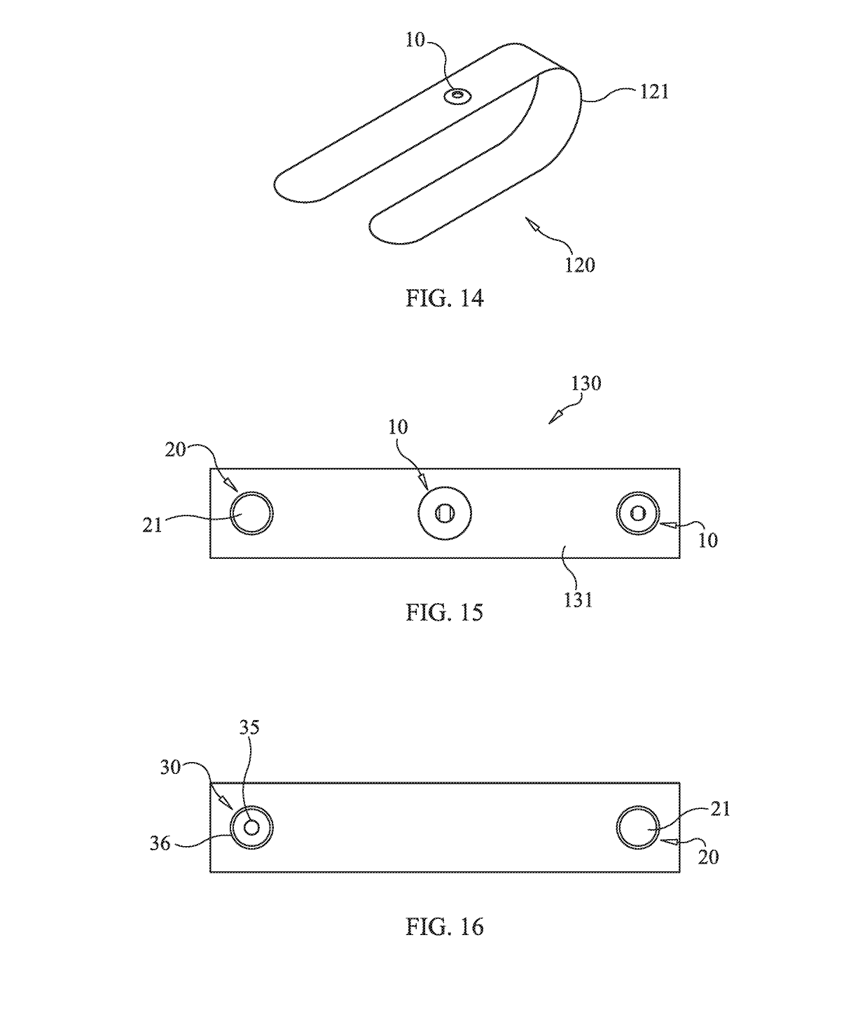

FIG. 14 shows a hairband assembly 120. The hairband assembly 120 includes a hairband 121. A female snap-fastener part 10 is disposed on the hairband 121. Accessories 40 and/or 50, which are not shown in FIG. 13, can be attached to the hairband 121 by snapping to the female snap-fastener part 10.

FIGS. 15-16 show a bracelet 130. The bracelet includes a band with a band exterior 131 and a band interior 132. A male snap 21 is placed on a first end of the band. A female snap 10 is disposed on a second end of the band. A female snap-fastener part 10 is disposed on the band exterior 13. Accessories 40 and/or 50, which are not shown in FIGS. 15-16, can be attached to the bracelet 130 by snapping to the female snap-fastener part 10.

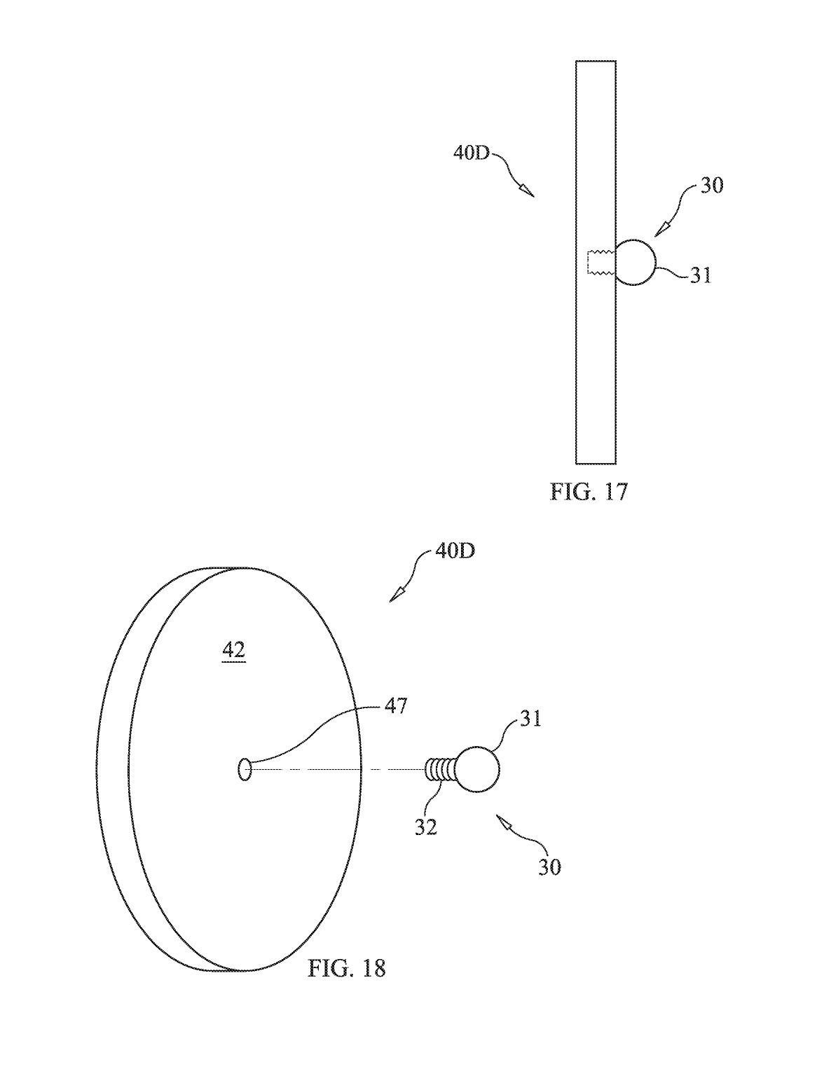

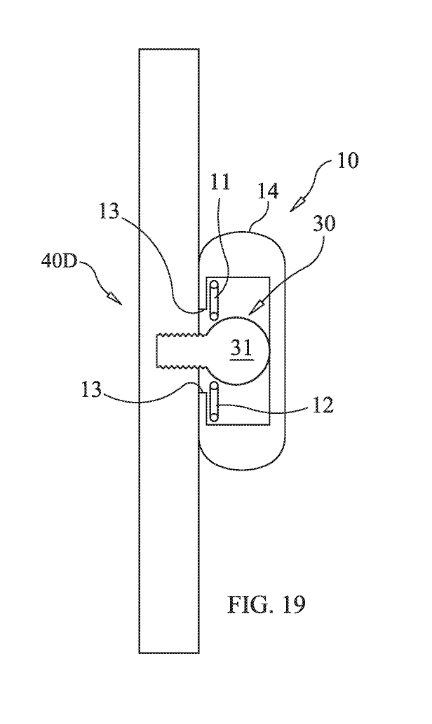

FIGS. 17-19 show an embodiment an ornament 40D that is configured to minimize rotation of the ornament 40D when the ornament 40D is installed in a female snap-fastener part 10 as shown in FIG. 19. In contrast to the embodiment shown in FIGS. 6-7, the groove sits flush against the interior 42 of the ornament 40. The springs 11-12 are positioned contact the underside of the groove 31, which pushes the interior 42 toward the exterior surface of the female snap-fastener part 10. As the surfaces are pressed against each other, the ornament is prevented from rotating relative to the female snap-fastener part 10.

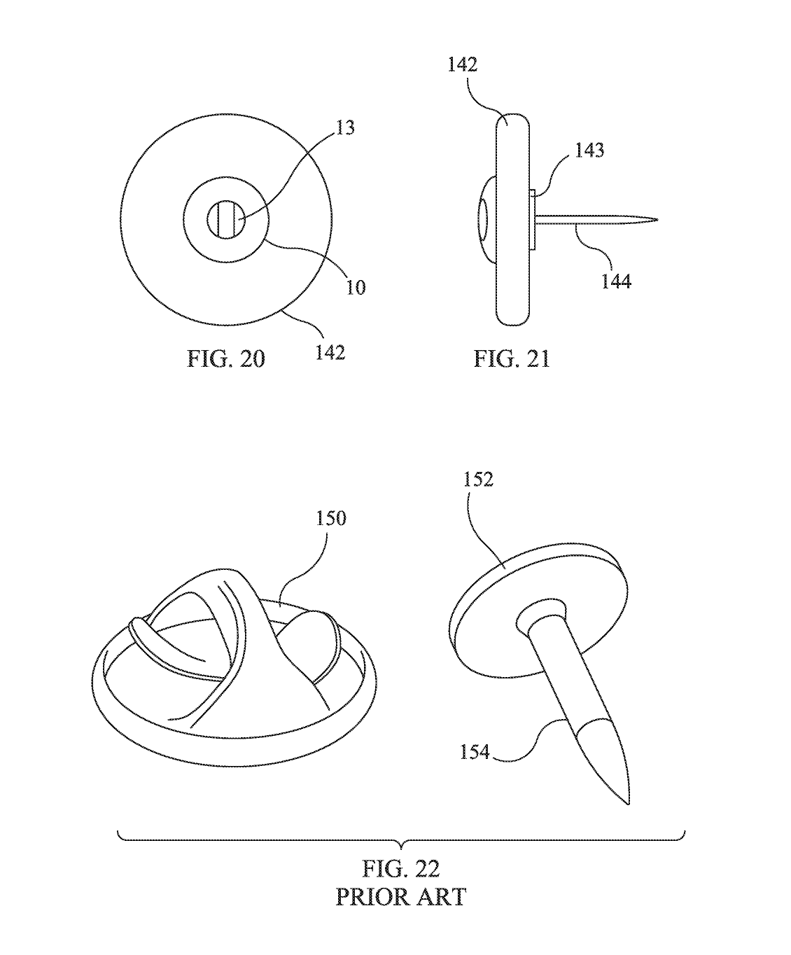

FIGS. 20-21 shown a lapel-pin female snap-fastener assembly. The lapel-pin female snap-fastener assembly includes a plate 142 having an exterior surface and an interior surface 143. A female snap-fastener part 10 is disposed on the exterior surface. The female snap-fastener part 10 has a socket 13 formed therein. The socket 13 is configured to receive a groove on a clothing ornament. FIGS. 4-5 show embodiments of clothing ornaments. A pin 144 is connected to the interior surface 143. The pin 144 is configured to pierce clothing such as a lapel.

FIG. 22 shows a lapel pin 152 according to the prior art. The lapel pin 152 has pin 154 disposed on a rear surface of the lapel pin 152. A butterfly clutch pin back 150 seats on the pin 154 to secure the lapel pin 152 to a piece of clothing.

Unless otherwise mentioned the reference numbers are used consistently throughout the figures.

What is claimed is:

1. An ornament for releasably attaching to an article, comprising:
an exterior surface having an ornament for decorating the article;
an interior surface opposing said exterior surface and having a threaded hole formed therein; and
a stud having a screw and a groove, said screw being screwed in said threaded hole, said groove being distally disposed on said screw.

2. The ornament according to claim 1, further comprising solder disposed in said threaded hole, said solder preventing said screw from unscrewing from said hole.

3. An accessory system for adorning an article, comprising:
a first ornament for decorating the article, said first ornament having a first groove disposed thereon;
a second ornament for decorating the article, said second ornament appearing different than said first ornament, and said second ornament having a second groove disposed thereon; and
a female snap-fastener part being configured to be mounted to the article, said female snap-fastener part having a socket formed therein, said female snap-fastener part being configured to receive in said socket only one of said first groove and said second groove at a given time, said female snap-fastener part being further configured to fasten said first ornament and said second ornament to said female snap-fastener part under normal use and to release said first ornament and said second ornament from said female snap-fastener part under hand pressure.

4. The accessory system according to claim 3, further comprising an article to be decorated, said article being connected to said female snap-fastener part.

5. The accessory system according to claim 3, further comprising a loop encircling said female snap-fastener part, said loop being held on said female snap-fastener part by said first ornament when said first groove is seated in said socket, and said loop being removable from said female snap-fastener part when said first groove is unseated from said socket.

6. The accessory system according to claim 5, further comprising an accessory for decorating the article, said accessory being connected to said loop.

7. The accessory system according to claim 6, wherein said accessory includes a dropper connected to said loop, said dropper extending below said first ornament when said loop is installed on said female snap-fastener part.

8. The accessory system according to claim 7, wherein said accessory includes a decoration for decorating the article, said decoration being connected to said dropper.

9. The accessory system according to claim 4, wherein said article is a chain for wearing around a neck, said chain being connected to said female snap-fastener part.

10. The accessory system according to claim 4, wherein:
said article includes fabric having an exterior surface and an interior surface;
said female snap-fastener part is disposed on said exterior surface; and
a rivet is inserted from said interior surface, through said fabric, and is securing said female snap-fastener part to said fabric.

11. A lapel-pin female snap-fastener assembly for connecting to a clothing ornament, comprising:
a plate having an exterior surface and an interior surface, said interior surface opposing said exterior surface;
a female snap-fastener part disposed on said exterior surface, said female snap-fastener part having a socket formed therein, said socket being configured to receive a groove on the clothing ornament; and
a pin connected to said interior surface, said pin being configured to pierce clothing.

12. An accessory system for adorning an article, comprising:
a male snap-fastener part having a groove; and
a female snap-fastener part having a socket formed therein, said female snap-fastener part being configured to receive said groove in said hole, said female snap-fastener part being further configured to hold said groove under normal use and to release said groove under hand pressure;
an ornament being connected to one of said male snap-fastener part and said female snap-fastener part; and
an article being connected to the other of said male snap-fastener part and said female snap-fastener part.

13. An ornament for removably attaching to a female snap fastener part, the female snap fastener part having a female-snap-fastener-part outer surface, the female-snap-fastener-part outer surface having a socket formed therein, a spring be disposed in the female-snap-fastener-part, the spring urging centerward with regard to the socket, the spring extending into a span of the socket when the spring is relaxed; the ornament comprising:
an exterior bearing a decoration;
a flat interior surface opposing said exterior; and
a groove being disposed on said flat interior surface, said groove having an overhang, said groove being sized small enough to seat in said socket with said flat interior surface abutting the female-snap-fastener-part outer surface, said groove being large enough to displace said spring when said groove is seated in said socket with said flat interior surface abutting the female-snap-fastener-part outer surface, said overhang being far enough from said flat interior surface to be held by said spring when said groove is seated in said socket with said flat interior surface abutting the female-snap-fastener-part outer surface, and said overhang being close enough to said flat interior surface to prevent said flat interior surface from separating from the female-snap-fastener-part-outer surface when said groove is seated in said socket.
